(19) United States
(12) Patent Application Publication
(10) Pub. No.: US 2002/0195793 A1
(43) Pub. Date: Dec. 26, 2002

(54) Trailer for a trike constructed from a motorcycle

(76) Inventor: Roger Gangwer, Tucson, AZ (US)

Correspondence Address: Antonio R. Durando, Durando Birdwell & Janke, P.L.C., 2929 E. Broadway Blvd., Tucson, AZ, 85716, US

(21) Appl. No.: 09/888,715

(22) Filed: Jun. 25, 2001

(51) Int. Cl. B62D 53/00

(52) U.S. Cl. 280/400

(57) ABSTRACT

A motorcycle carries a saddlebag on either side, and each saddlebag has several openings which are used to secure the respective saddlebag to the motorcycle. The saddlebags are removed from the motorcycle and the motorcycle is converted to a trike. The saddlebags are mounted on a trailer which can be hitched to the trike, and the trailer is designed so that the saddlebags can be secured to the trailer via the openings which were used to secure the saddlebags to the motorcycle. The trailer runs on a single tire which is supported by a cantilevered axle. The trailer has a rear bumper provided with feet onto which the trailer can be tilted for storage.

### FIELD OF THE INVENTION

The invention relates to a trailer.

### DESCRIPTION OF THE PRIOR ART

Motorcycles are generally equipped with a pair of saddlebags which allow the riders to store their belongings while riding.

When a motorcycle is stopped, the driver must put down his or her feet in order to keep the motorcycle upright. Since this can be tiring, many motorcycle owners eventually choose to convert their motorcycles to trikes which are three-wheeled modifications of the motorcycles.

Upon conversion of a motorcycle to a trike, the portion of the motorcycle which holds the saddlebags is modified in such a manner that the saddlebags can no longer be attached thereto. Consequently, the saddlebags become useless and must either be stored or discarded.

### SUMMARY OF THE INVENTION

It is an object of the invention to provide a means and method for using storage units discarded from motorcycles.

The preceding object, as well as others which will become apparent as the description proceeds, are achieved by the invention.

One aspect of the invention resides in a trailer. The trailer comprises a support, at least one rolling element for carrying the support, and means for connecting the support to a tow vehicle.

According to one embodiment of the trailer, the trailer further comprises at least one storage unit which is fixed to the support and is designed to be mounted on a motorcycle.

By providing a trailer which is capable of carrying a motorcycle storage unit, it becomes possible to continue using a storage unit which has been discarded from a motorcycle. If the motorcycle is converted to a trike, the trailer can be designed to be hitched to the trike.

The stability of a trailer can be enhanced by making the center of gravity low. This can present a problem when the location at which the trailer is to be hitched to the tow vehicle is high.

Another embodiment of the trailer enables this problem to be overcome.

In accordance with this embodiment of the trailer, the means for connecting the support to a tow vehicle includes a towing member having a first portion for attachment to the support, a second portion for attachment to the tow vehicle, and a third portion between the first portion and the second portion. The third portion is inclined to the first portion and to the second portion.

The inclined portion of the towing member makes it possible to compensate for a height differential between a trailer and a location at which the trailer is to be hitched to a tow vehicle. The inclined portion enables the two other portions of the towing member to be positioned at respective heights which not only allow the towing member to be securely connected with the trailer and the tow vehicle but also allow the trailer to be in an upright position.

According to an additional embodiment of the trailer, the means for connecting the support to a tow vehicle includes a towing member and a discrete connecting member for connecting the towing member to the tow vehicle. The towing member has a first portion for attachment to the support and a second portion for attachment to the tow vehicle while the connecting member has a first portion for pivotal attachment to the second portion of the towing member and a second portion for pivotal attachment to the tow vehicle.

When the trailer is hitched to the tow vehicle, the connecting member defines two pivot axes between the trailer and the tow vehicle. These pivot axes make it possible for the trailer to follow the tow vehicle relatively easily and smoothly. For instance, one of the pivot axes may be generally vertical to allow the trailer to smoothly follow the tow vehicle around a corner. The second pivot axis may be generally horizontal so that the tow vehicle can pass over a bump without causing the trailer to bounce uncontrollably.

In accordance with a further embodiment of the trailer, the support is provided with a single axle and the rolling element which carries the support is mounted on the axle.

The use of a single axle for the support permits an off-the-shelf axle to be employed. This enables the cost of the trailer to be reduced.

An additional aspect of the invention resides in a kit for making a trailer. The kit comprises a support, and means for connecting the support to a tow vehicle. The kit also comprises a rolling element for carrying the support, and means for mounting the rolling element on the support.

Another aspect of the invention resides in a method of making and using a trailer. The method comprises the steps of assembling a support and a rolling element for carrying support, and connecting the support to a tow vehicle.

One embodiment of the method further comprises the steps of removing a storage unit from a motorcycle and mounting the storage unit on the support. The tow vehicle can here, for example, be a trike derived from the motorcycle.

In accordance with another embodiment of the method, the connecting step involves attaching a towing member to the support, pivotally attaching the towing member to a connecting member, and pivotally attaching the connecting member to the tow vehicle.

The towing member can be attached to the connecting member for pivotal movement on a first axis and the connecting member attached to the tow vehicle for pivotal movement on a second axis. If the first axis extends along a first direction, the second axis may extend along a second direction which is substantially normal to the first direction.

According to a further embodiment of the method, the support is provided with a single axle and the step of assembling the support and the rolling element comprises mounting the rolling element on the axle.

In the latter embodiment of the method, the assembling step can further comprise cantilevering the axle on the support.

Additional features and advantages of the invention will be forthcoming from the following detailed description of preferred embodiments when read in conjunction with the accompanying drawings.

### BRIEF DESCRIPTION OF THE DRAWINGS

FIG. 1 is a perspective view of a trailer which is designed in accordance with the invention and carries a pair of storage units designed to be mounted on a motorcycle.

FIG. 2 is a perspective view of the trailer without the storage units.

FIG. 3 is a partly sectional plan view of one part of the trailer.

FIG. 4 is a partly sectional elevational view of another part of the trailer.

FIG. 5 is an exploded perspective view of an axle assembly forming part of the trailer.

FIG. 6a is a plan view of a bumper constituting part of the trailer.

FIG. 6b is a side view of the bumper as seen in the direction of the arrow B in FIG. 6a.

FIG. 7 is a partly sectional side view of a drawbar forming part of the trailer.

FIG. 8a is a partly sectional elevational view of a connecting member for attaching the towing member to a tow vehicle.

FIG. 8b is a side view of the connecting member.

FIG. 9 shows a kit containing components of the trailer.

FIG. 10 is a side view of a motorcycle which is to be converted to a trike and is equipped with storage units to be transferred to the trailer upon conversion.

FIG. 11 is a side view of the trike and the trailer.

FIG. 12 is a rear view of the trailer.

### DESCRIPTION OF THE PREFERRED EMBODIMENTS

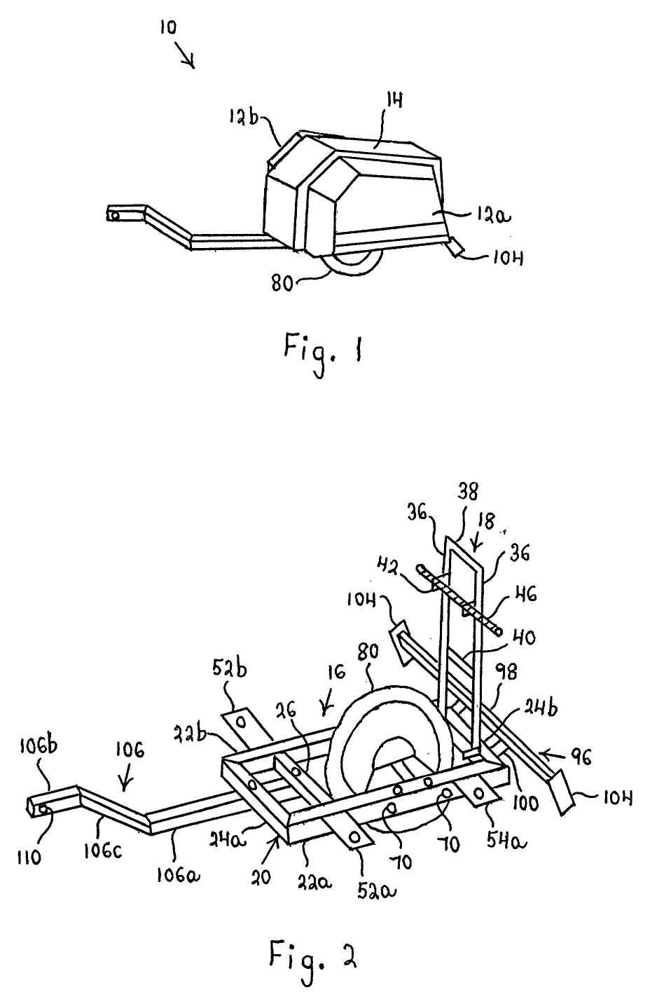

Referring to FIGS. 1 and 2, the numeral 10 identifies a trailer according to the invention. The trailer 10 includes two saddlebags or storage units 12a and 12b of the type found on certain motorcycles, and it is here assumed that the saddlebags 12a,12b were taken from a motorcycle which is to be converted to a trike. The saddlebags 12a,12b define a non-illustrated gap which is covered by a tonneau cover 14. The saddlebags 12a,12b and the tonneau cover 14 have cooperating, non-illustrated male and female snap portions or elements for securing the tonneau cover 14 to the saddlebags 12a, 12b. The trailer 10 further includes a carrier or support which carries the saddlebags 12a,12b and is made up of a carrying part 16 and a holding part 18.

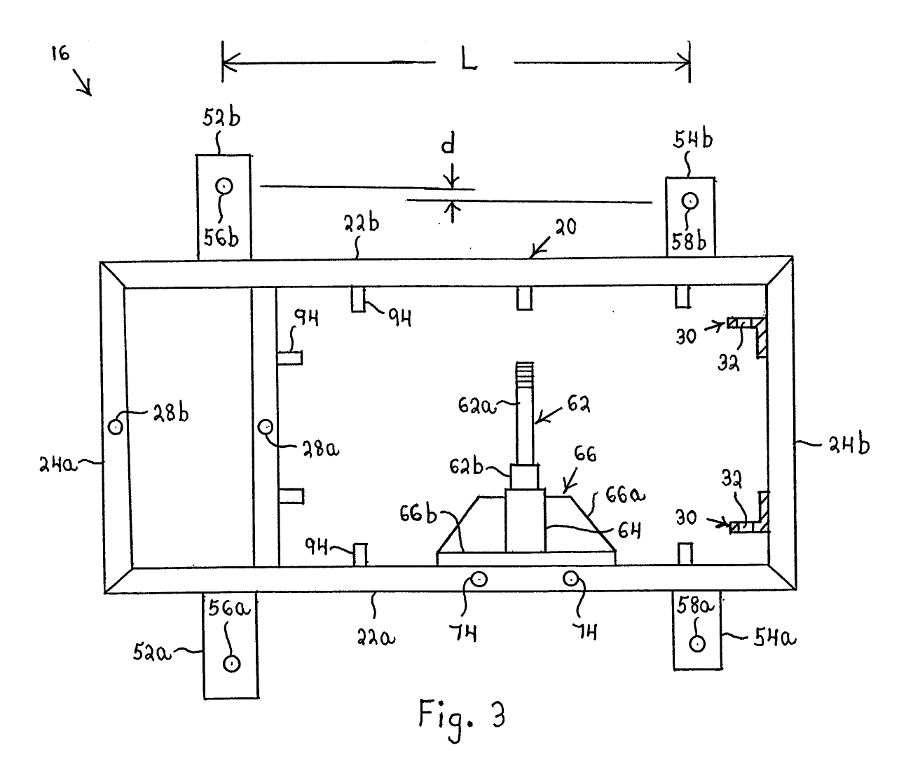

Considering FIGS. 2 and 3, the carrying part 16 of the carrier 16, 18 comprises a rectangular frame or frame-like member 20 having two parallel longer legs 22a and 22b and two parallel shorter legs 24a and 24b. The shorter leg 24a is located at the front of the carrying part 16 and the shorter leg 24b at the rear. The carrying part 16 additionally comprises a reinforcing member 26 which is parallel to the shorter legs 24a,24b and bridges the longer legs 22a,22b. The reinforcing member 26 is located closer to the shorter leg 24a than to the shorter leg 24b, and the reinforcing member 26 is provided with an opening 28a midway along its length while the shorter leg 24a is provided with an opening 28b midway along its length. The axes of the openings 28a,28b are normal to the plane defined by the frame 20.

The legs 22a,22b,24a,24b are here made of bar. The two ends of each leg 22a,22b,24a,24b are beveled to form a surface which makes an angle of 45 degrees with the longitudinal axis of the respective leg 22a,22b,24a,24b. The adjoining ends of two legs 22a,22b,24a,24b are mitered and can be joined by a seam weld.

The shorter leg 24b has a surface which faces the inside of the frame 20, and a pair of spaced brackets or mounting elements 30 is mounted on this inner surface of the shorter leg 24b. The brackets 30 are in the form of angle irons, and one leg of each angle iron 30 lies flat against the inner surface of the shorter leg 24b while the other leg projects to the interior of the frame 20. The projecting legs define planes which are parallel to the longer legs 22a,22b and normal to the plane defined by the frame 20, and each of the projecting legs is provided with an opening 32. The axes of the openings 32 lie on a common line which is perpendicular to the longer legs 22a,22b.

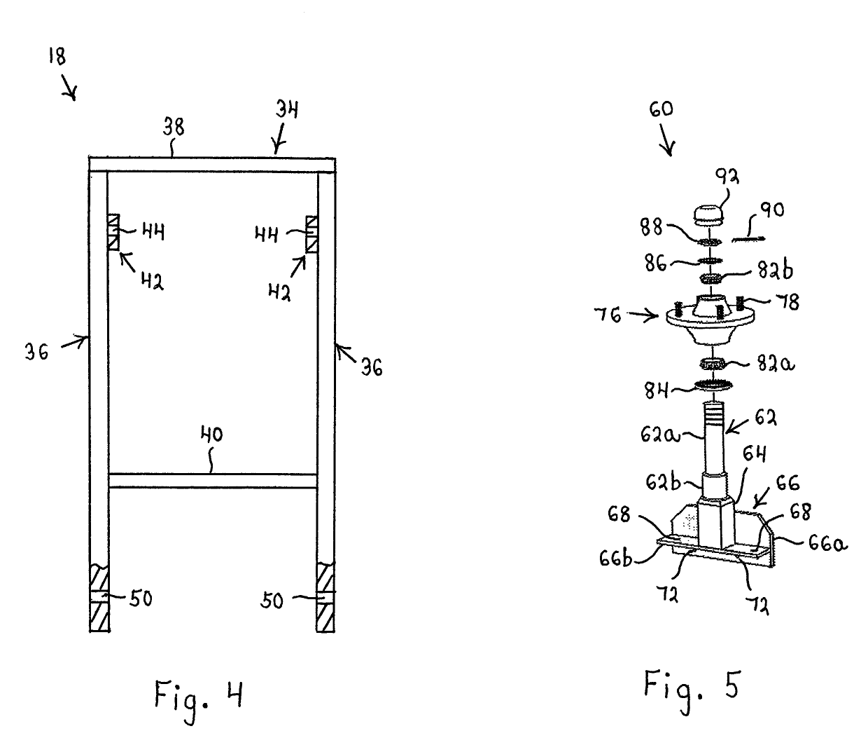

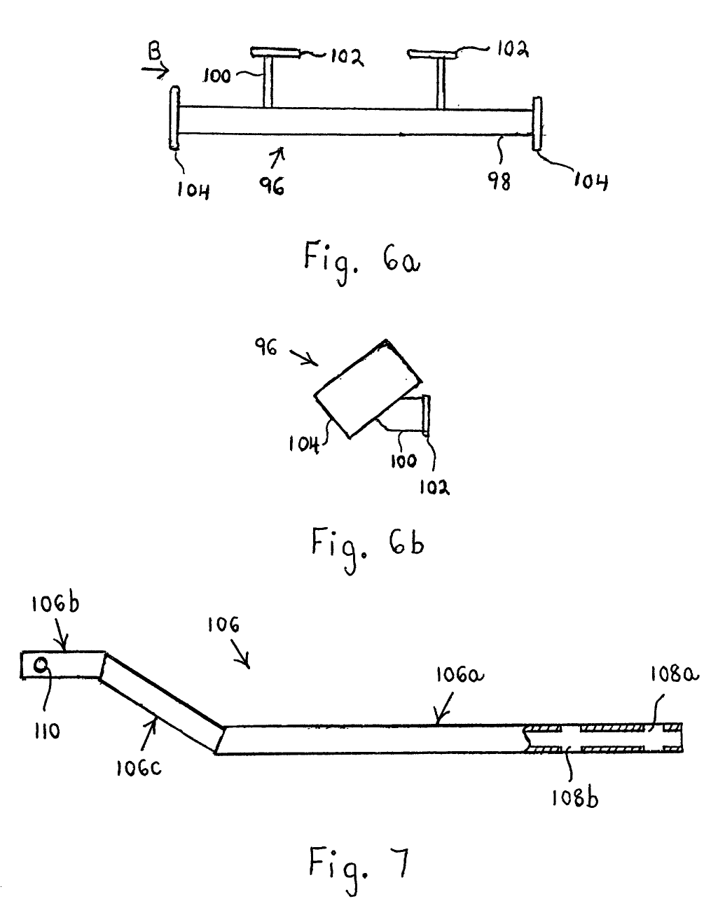

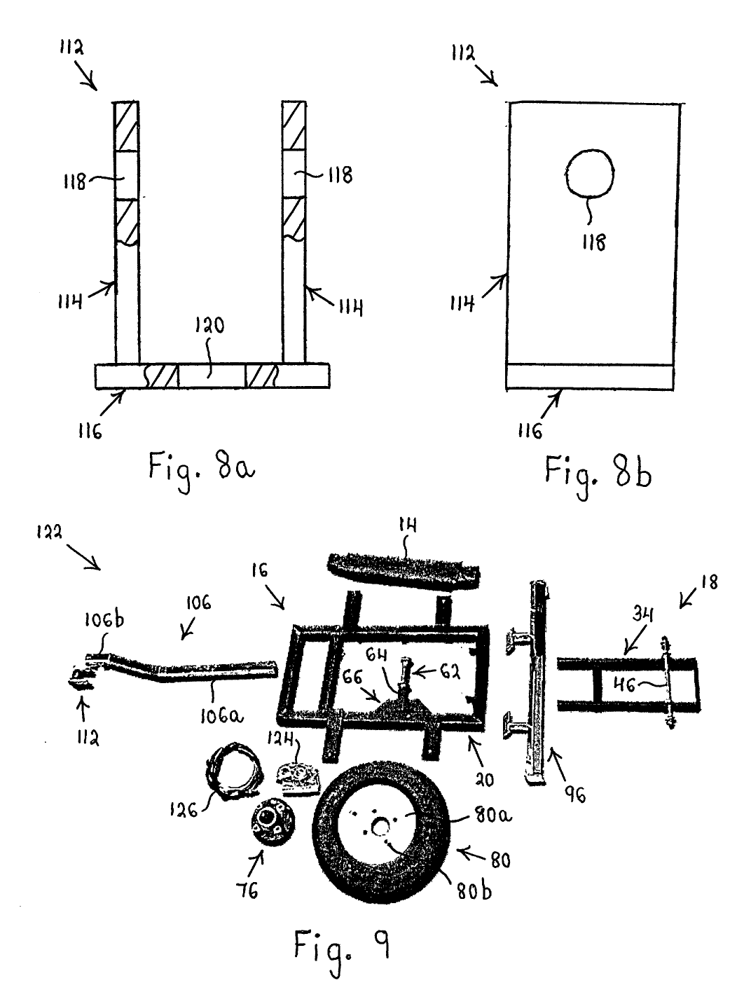

The angle irons 30 support the holding part 18 of the carrier 16,18. Referring to FIG. 4 together with FIGS. 1 and 2, the holding part 18 includes a U-shaped member 34 having a pair of parallel legs 36 and a crosspiece or bridging element 38 which extends in a direction perpendicular to the legs 36 and joins an end of one of the legs 36 to an end of the other leg 36. The legs 36 have free ends remote from the crosspiece 38, and the holding part 18 further includes a reinforcing member 40 which is parallel to the crosspiece 38 and bridges the legs 36. The reinforcing member 40 is located closer to the free ends of the legs 36 than to the crosspiece 38.

A bracket or mounting element 42 is affixed to each of the legs 36 of the holding part 18. The U-shaped member 34 of the holding part 18 defines a plane, and the brackets 42 project to one side of such plane. As seen in FIG. 2, the brackets 42 project towards the shorter leg 24a of the frame 20.

The brackets 42 are located directly opposite one another and closer to the reinforcing member 40 than to the free ends of the legs 36. Each of the brackets 42 is provided with an opening 44, and a holding rod or elongated holding member 46 bridges the brackets 42 and passes through the openings 44. Each end of the holding rod 46 is located to the outside of the respective bracket 42. The holding rod 46 normally carries washers and nuts which are not shown in FIG. 2, and the holding rod 46 is threaded, preferably along the entire length thereof. The holding rod 46 passes through a non-illustrated hole in each of the saddlebags 12a,12b and serves to secure the saddlebags 12a,12b to the holding part 18. The holes in the saddlebags 12a,12b which receive the holding rod 46 can be original holes formed in the factory when the saddlebags 12a,12b were new, i.e., can be the same holes which were used to mount the saddlebags 12a,12b on the motorcycle from which the saddlebags 12a,12b were removed. This would make it unnecessary to form additional holes in the saddlebags 12a,12b.

As illustrated in FIG. 4, the free end of each leg 36 of the U-shaped member 34 is provided with an opening 50 having an axis which is perpendicular to the respective leg 36. The spacing between the legs 36 is such that the legs 36 can be placed between the projecting legs of the angle irons 30 mounted on the frame 20. Each of the legs 36 can then be positioned adjacent one of the angle iron legs with the opening 50 of the respective leg 36 in alignment with the opening 32 of the adjoining angle iron leg. The holding part 18 can then be mounted on the carrying part 16 by inserting a bolt in each pair of aligned openings 32,50.

Considering FIGS. 2 and 3, a rectangular bracket or mounting element 52a projects at a right angle from the longer leg 22a of the frame 20. Directly opposite the bracket 52a, a second rectangular bracket or mounting element 52b projects at a right angle from the longer leg 22b. The brackets 52a,52b extend outward of the frame 20 and are located near the shorter leg 24a thereof. Another rectangular bracket or mounting element 54a projects at a right angle from the longer leg 22a of the frame 20. Directly opposite the bracket 54a, an additional rectangular bracket or mounting element 54b projects at a right angle from the longer leg 22b. The brackets 54a,54b extend outward of the frame 20 and are located near the shorter leg 24b thereof.

The brackets 52a,54a serve to support the saddlebag 12a and the brackets 52b,54b to support the saddlebag 12b. The brackets 52a and 52b are provided with respective openings 56a and 56b while the brackets 54a,54b are provided with respective openings 58a and 58b. The axes of the openings 56a,56b,58a,58b are parallel to the axis of the opening 28a in the reinforcing member 26 and the axis of the opening 28b in the shorter leg 24a of the frame 20.

The saddlebag 12a has non-illustrated holes which can be aligned with the openings 56a,58a in order to allow the saddlebag 12a to be secured to the brackets 52a,54a. Similarly, the saddlebag 12b has non-illustrated holes which can be aligned with the openings 56b,58b so that the saddlebag 12b may be secured to the brackets 52b,54b. The holes in the saddlebag 12a which are to be aligned with the openings 56a,58a, as well as the holes in the saddlebag 12b which are to be aligned with the openings 56b,58b, can be original holes formed in the factory when the saddlebags 12a,12b were new, i.e., can be the same holes which were used to mount the saddlebags 12a,12b on the motorcycle from which the saddlebags 12a,12b were taken. The distance between the holes in the saddlebag 12a which are to be aligned with the openings 56a,58a, and also the distance between the holes in the saddlebag 12b which are to be aligned with the openings 56b,58b, is then the same as the distance “L” between the openings 56a,58a and between the openings 56b,58b.

By way of example, the distance “L” for saddlebags 12a,12b removed from a Honda 1500 cc motorcycle known as the GL 1500 is 13 inches. Moreover, for such saddlebags 12a,12b, the openings 56a,58a, as well as the openings 56b,58b, are laterally offset by a distance “d” of 11/16 inch.

FIG. 5 shows an axle assembly 60 for the frame 20. The axle assembly 60 includes an axle 62 having a main portion 62a of smaller diameter and an abutment portion 62b of larger diameter. The abutment portion 62b is fixed to a rectangular block 64 which, in turn, is fixed to a mount 66.

The mount 66 comprises an elongated base plate 66a and an elongated secondary plate 66b which is fixed to a major surface of the base plate 66a. The secondary plate 66b is perpendicular to and runs the length of the base plate 66a. The rectangular block 64 has a flat end face which is remote from and perpendicular to the axle 62, and the end face is fixed to one of the major surfaces of the secondary plate 66b. The rectangular block 64 further has four flat major faces which are perpendicular to the end face, and one of these major faces is fixed to the same major surface of the base plate 66a as the secondary plate 66b. The rectangular block 64 is located midway along the length of the base plate 66a and midway along the length of the secondary plate 66b.

Referring to FIG. 3 in conjunction with FIG. 5, the secondary plate 66b is provided with a hole 68 on either side of the block 64. The holes 68 are designed to be aligned with two holes 70 (see FIG. 2) in the longer leg 22a of the frame 20. The axes of the holes 70 are parallel to the shorter legs 24a,24b of the frame 20. The holes 68 in the secondary plate 66b and the corresponding holes 70 in the longer leg 22a allow the secondary plate 66b to be bolted to the longer leg 22a.

The base plate 66a is provided with two holes 72 on the side of the secondary plate 66b remote from the block 64. One of the holes 72 is located to either side of the block 64, and the holes 72 are designed to be aligned with two holes 74 in the longer leg 22a of the frame 20. The axes of the holes 74 are parallel to the axes of the openings 28a,28b,56a,56b,58a,58b. The holes 72 in the base plate 66a and the corresponding holes 74 in the longer leg 22a permit the base plate 66a to be bolted to the longer leg 22a. When the base plate 66a is fastened to the longer leg 22a, the axle 62 is cantilevered on the frame 20, i.e., one end of the axle 62 is fixed to the frame 20 while the other end remains free.

As illustrated in FIG. 5, the axle assembly 60 further comprises a hub 76 having four threaded shafts 78 (only three visible in FIG. 5) projecting to one side thereof. The shafts 78 are designed to pass through holes in the rim of a tire or rolling element 80 (see FIGS. 1 and 2) which can then be secured to the hub 76 by lug nuts. The tire 80 supports the trailer 10 for movement.

The hub 76 is mounted for rotation on the main axle portion 62a of the axle 62 by way of two roller bearings 82a and 82b. The roller bearing 82a is located on the side of the hub 76 which faces the abutment portion 62b of the axle 62, and a seal 84 for the roller bearing 82a sits on the main axle portion 62a against the abutment portion 62b. On the other hand, the roller bearing 82b is located on the side of the hub 76 which faces the free end of the axle 62, and a washer 86 and jam nut 88 sit on the main axle portion 62a between the bearing 82b and the free end of the axle 62. The hub 76 is retained on the axle 62 by a cotter pin 90, and a dust cover cap 92 is mounted on the axle 62 at the free end thereof.

The axle 62 is the only axle on the trailer 10. The use of only one axle makes it possible to employ an off-the-shelf axle for the trailer 10.

Referring back to FIG. 3, the reinforcing member 26 and the longer legs 22a,22b of the frame 20 are provided with bendable tabs 94. The tabs 94 project to the inside of the rectangle defined by the reinforcing member 26, the longer legs 22a,22b and the shorter leg 24b of the frame 20. The tabs 94 function to support a wire harness which conducts power from a tow vehicle serving to pull the trailer 10 to lights at the rear of the trailer 10.

Considering FIGS. 2, 6a and 6b, a rear bumper for the trailer 10 is identified by the numeral 96. The bumper 96 includes an elongated protective member 98 which is here in the form of a square tube. Two supporting elements 100, which can be made from flat plate or sheet, project to one side of the protective tube 98 at right angles to the longitudinal axis of the tube 98. The supporting elements 100 are spaced from one another longitudinally of the tube 98, and each of the supporting elements 100 has a free end remote from the tube 98. The free ends of the supporting elements 100 are located at the same distance from the tube 98, and a mounting element 102 is secured to the free end of each supporting element 100.

The mounting elements 102, which can be constituted by flat plate or sheet, are parallel to the longitudinal axis of the tube 98. Each of the mounting elements 102 is provided with a non-illustrated hole having an axis which is perpendicular to the longitudinal axis of the tube 98. The holes in the mounting elements 102 are designed to be aligned with respective non-illustrated holes in the shorter leg 24b of the frame 20. When the holes in the mounting elements 102 are aligned with the corresponding holes in the shorter leg 24b, the bumper 96 can be bolted to the shorter leg 24b.

A rectangular foot 104, which can be made from flat plate or sheet, is secured to either end of the tube 98. The feet 104 are fixed to the tube 98 such that the feet 104 are inclined to the horizontal when the trailer 10 is in its upright position, that is, in the position assumed by the trailer 10 while being towed. In this position, the feet 104 slope downward in a direction away from the front of the trailer 10 and project to a level below that of the tube 98. The design of the feet 104 allows the trailer 10 to be tilted backward onto the feet 104 for storage. By way of example, the trailer 10 can be stored leaning against a wall.

The trailer 10 additionally comprises means for connecting the trailer 10 to a tow vehicle which is to pull the trailer 10.

Turning to FIG. 7 in conjunction with FIGS. 1, 2 and 3, the means for connecting the trailer 10 to a tow vehicle includes a drawbar or towing member 106. The drawbar 106, which is here made from square tubing, has an elongated portion 106a provided with two passages 108a and 108b. The passages 108a and 108b can be aligned with the respective openings 28a and 28b in the reinforcing member 26 and the shorter leg 24a of the frame 20. When the passages 108a,108b are aligned with the openings 28a, 28b, the drawbar 106 can be bolted to the frame 20.

The drawbar 106 has another elongated portion 106b which is shorter than the frame attachment portion 106a. The elongated portion 106b is provided with a passage 110 which is used to connect the drawbar 106 to a powered or motorized tow vehicle, e.g., a trike, capable of towing the trailer 10. The axis of the passage 110 extends in a direction transverse to the axes of the passages 108a,108b.

The frame attachment portion 106a and tow vehicle attachment 106b are offset, and the frame attachment portion 106a or its longitudinal axis is parallel to the tow vehicle attachment portion 106b or its longitudinal axis.

The frame attachment portion 106a has an end which faces in a direction towards the tow vehicle attachment portion 106b while the tow vehicle attachment portion 106b has an end which faces in a direction towards the frame attachment portion 106a. These ends are joined to one another by an additional elongated portion 106c of the drawbar 106. The joining portion 106c or its longitudinal axis is inclined to the frame attachment portion 106a or its longitudinal axis and to the tow vehicle attachment portion 106b or its longitudinal axis. By way of example, the angle of inclination, alpha, can be 22 degrees.

Considering FIGS. 8a and 8b with FIG. 7, the means for connecting the trailer 10 to a tow vehicle further includes a hinge or connecting member 112 which is separate or discrete from the drawbar 106. The hinge 112 is U-shaped and has two legs 114 as well as a crosspiece or bridging element 116 which bridges the legs 114 and joins the legs 114 to each other. The legs 114 and crosspiece 116 are flat and can be made from flat plate or sheet.

Each of the legs 114 is provided with an opening 118 near the end thereof remote from the crosspiece 116, and the axes of the openings 118 lie on a common line. The legs 114 are spaced from one another to define a gap, and the width of the gap is such that the joining portion 106c of the drawbar 106 fits in the gap with some clearance. The joining portion 106c can be inserted in the gap so that the passage 110 is in register with the openings 118. The connecting member 112 can then be pivotally connected to the drawbar 106 by inserting a pivot in the passage 110 and the openings 118.

The crosspiece 116 of the hinge 112 is formed with a central opening 120, and the axis of the opening 120 is perpendicular to the axes of the openings 118. The opening 120 can be aligned with a hole in the hitch of a tow vehicle for the trailer 10, and the hinge 112 can thereupon be pivotally connected to the tow vehicle by inserting a pivot in the opening 120 and the registering hole of the hitch.

When the trailer 10 is connected to a tow vehicle via the connecting means 106,112, the hinge 112 will normally be positioned with the crosspiece 116 facing down and the free ends of the legs 114 facing up. The connecting means 106,112 allows the tow vehicle and the trailer 10 to pivot relative to one another about two mutually perpendicular axes. These two axes will generally be vertical or approximately vertical and horizontal or approximately horizontal.

The means 106,112 for connecting the trailer 10 to a tow vehicle is designed to hold the trailer 10 upright when the trailer 10 is hitched to a tow vehicle.

As shown in FIG. 9, the components of the trailer 10 other than the saddlebags 12a,12b may be supplied in the form of a kit 122. The kit 122, which will normally comprise a suitable, non-illustrated package or container, includes the following:

(a) The carrying part 16 of the support 16,18, i.e., the frame 20 with the reinforcing member 26, the angle irons 30, the brackets 52a,52b,54a,54b and the tabs 94.

(b) The holding part 18 of the support 16,18, namely, the U-shaped member 34 with the reinforcing member 40 and the brackets 42.

(c) The holding rod 46 which passes through the brackets 42. In the kit 122, the holding rod 46 may be mounted on the U-shaped member 34 as illustrated.

(d) The axle 62 with the block 64 and mount 66 which hold the axle 62. In the kit 122, the axle 62, block 64 and mount 66 may be secured to the frame 20 as illustrated.

(e) The tire 80.

(f) The hub 76, roller bearings 82a,82b, inner seal 84, washer 86, jam nut 88, cotter pin 90 and dust cover cap 92 for mounting the tire 80 on the axle 62. The roller bearings 82a,82b are contained in a bag 124 as are the inner seal 84, the jam nut 88 and the cotter pin 90. On the other hand, the washer 86 and dust cover cap 92 can either be mounted on the axle 62 as illustrated or included in the bag 124.

(g) The rear bumper 96.

(h) The drawbar 106 and hinge 112.

(i) The tonneau cover 14.

(j) A wire harness 126 for conducting power from a tow vehicle serving to pull the trailer 10 to lights at the rear of the trailer 10.

(k) Hardware for assembling the trailer 10 including washers, hex nuts, lug nuts, nylock nuts, bolts, rivets and snaps. FIG. 9 shows washers and nuts on the holding rod 46.

(l) Assembly instructions.

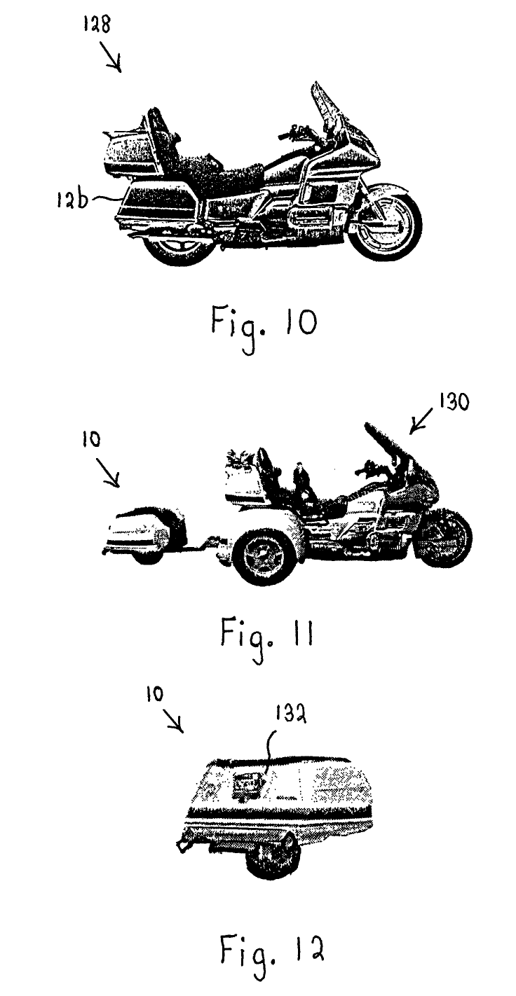

Assuming that a motorcycle 128 illustrated in FIG. 10 is equipped with the saddlebags 12a and 12b (only the saddlebag 12b is visible in FIG. 10), one method of making and using the trailer 10 is as follows:

The saddlebags 12a and 12b are removed from the motorcycle 128, and the motorcycle 128 is converted to a trike, i.e., a motorbike with three wheels, in a well-known manner which does not form part of the invention. The trike, which is denoted by the numeral 130 in FIG. 11, is to serve as a tow vehicle for the trailer 10.

The kit 122 is opened and the carrying part 16 of the support 16,18 withdrawn. In the illustrated kit 122, the unit including the axle 62, block 64 and mount 66 is secured to the frame 20 of the carrying part 16 while the washer 86 and dust cover cap 92 are mounted on the axle 62. The unit including the axle 62, block 64 and mount 66 is detached from the frame 20, and the washer 86 and dust cover cap 92 are retrieved from the axle 62. The bag 124 is opened, and the roller bearings 82a,82b, the inner seal 84, the jam nut 88 and the cotter pin 90 are removed from the bag 124.

The unit including the axle 62, block 64 and mount 66 is positioned with the axle 62 projecting upward from the block 64. By way of example, this can be accomplished by clamping the block 64 and mount 66 in a vise. The roller bearing 82a is packed with grease and inserted in the hub 76 on the side thereof which is to face the block 64, i.e., on the side of the hub 76 which faces away from the threaded shafts 78 (FIG. 5). The inner seal 84 is inserted in the same side of the hub 76 as the roller bearing 82a, and the hub 76 is then lowered onto the axle 62 with the threaded shafts 78 facing away from the block 64. After being packed with grease, the second roller bearing 82b is inserted in the hub 76 on the side of the hub 76 which faces away from the block 64.

The washer 86 and jam nut 88 are now installed on the axle 62 and the roller bearings 82a,82b are seated. The cotter pin 90 is passed through the axle 62 and spread and the dust cover cap 92 is placed on the free end of the axle 62. Preferably, the inside of the dust cover cap 92 is smeared with grease before the cap 92 is placed on the axle 62.

As seen in FIG. 9, the tire 80 has a rim 80a with four openings 80b corresponding to the four shafts 78 on the hub 76. The tire 80 is mounted on the hub 76 by passing the shafts 78 through the openings 80b and screwing lug nuts onto the shafts 78. The lug nuts form part of the kit 122 although they are not shown in FIG. 9.

Once the tire 80 has been secured on the axle 62, the mount 66 is again fastened to the frame 20.

As indicated previously, the drawbar 106 is made of square tubing. The wire harness 126, which is supplied in a coiled condition as seen in FIG. 9, is straightened and fed through the drawbar 106. The wire harness 126 is adjusted so that the harness 126 protrudes from the frame attachment portion 106a of the drawbar 106 as well as from the tow vehicle attachment portion 106b.

Following adjustment of the wire harness 126 in the drawbar 106, the drawbar 106 is fixed to the carrying part 16 of the support 16,18. Thus, the passage 108b in the drawbar 106 (FIG. 7) is aligned with the opening 28b in the shorter leg 24a of the frame 20 (FIG. 3) while the passage 108a in the drawbar 106 (FIG. 7) is aligned with the opening 28a in the reinforcing member 26 (FIG. 3). The drawbar 106 is thereupon attached to the shorter leg 24a and the reinforcing member 26 via bolts, washers and nuts. Care should be exercised not to pinch the wire harness 126.

The wire harness 126 includes two differently colored wires which can be encased by a sheath in the section of the wire harness 126 running through the drawbar 106 and out of the tow vehicle attachment portion 106b. The sheath terminates at or near the end of the frame attachment portion 106a remote from the joining portion 106c so that the two wires in the section of the wire harness 126 which protrudes from the frame attachment portion 106a can be separated.

After the drawbar 106 has been fixed to the carrying part 16 of the support 16,18, one of the wires is guided over the tabs 94 (FIG. 3) located on the right side of the frame 20 while the other of the wires is guided over the tabs 94 on the left side of the frame 20. The wires extend beyond the rearmost tabs 94, and the wire on the right side of the frame 20 is passed underneath the longer leg 22b to the outside of the frame 20 rearward of the respective rearmost tab 94. Similarly, the wire on the left side of the frame 20 is passed underneath the longer leg 22a to the outside of the frame 20 rearward of the corresponding rearmost tab 94. The tabs 94 are bent upwards to fix the wires in place.

Considering FIGS. 3 and 4, the holding part 18 of the support 16,18 is now mounted on the carrying part 16. The legs 36 of the U-shaped member 34 are placed between the angle irons 30 so that each leg 36 is located adjacent to one of the angle irons 30. The holding part 18 is positioned with the brackets 42 facing the front of the carrying part 16 and with the opening 50 in each leg 36 in alignment with the opening 32 in the adjoining angle iron 30. A bolt is inserted in each pair of aligned openings 32,50 and the holding part 18 is secured to the carrying part 16 by screwing nuts onto the respective bolts.

Assuming that the kit 122 comes with the holding rod 46 mounted on the U-shaped member 34 as shown in FIG. 9, the holding rod 46 passes through the openings 44 in the brackets 42. The holding rod 46 projects from each bracket 42 to the outside of the U-shaped member 34, and the projecting sections of the holding rod 46 have the same length or approximately the same length. Two nuts are situated on the section of the holding rod 46 which is located between the legs 36 of the U-shaped member 34 while three nuts and two washers are situated on each of the projecting sections. The washers on each projecting section are located between the two outermost nuts.

The outermost nut and outermost washer are removed from each of the projecting sections of the holding rod 46 while the second washer and its adjoining nut are positioned away from the end of the respective projecting section leaving each projecting section with a free end portion. One of the free end portions is designed to pass through a non-illustrated opening in a side wall of the saddlebag 12a, and the saddlebag 12a is now placed on the carrying part 16 of the support 16,18 with the side wall opening facing this free end portion. The free end portion is passed through the side wall opening so that it projects into the interior of the saddlebag 12a and one of the washers previously removed from the holding rod 46 is placed on the free end portion followed by one of the nuts previously removed from the holding rod 46.

The bottom of the saddlebag 12a has two non-illustrated openings which can be aligned with the openings 56a,58a in the brackets 52a,54a of the carrying part 16 (FIG. 2). Upon alignment of the openings in the bottom of the saddlebag 12a with the openings 56a,58a, washers are placed on two bolts which are then inserted in the two pairs of aligned openings. Subsequent to insertion of the bolts in the aligned openings, another washer is placed on each bolt followed by a nut.

After the saddlebag 12a has been mounted on the carrying part 16 of the support 16,18, the saddlebag 12b is placed on the carrying part 16. The second free end portion of the holding rod 46 is designed to pass through a non-illustrated opening in a side wall of the saddlebag 12b, and the saddlebag 12b is positioned with such opening facing the second free end portion. The second free end portion is passed through the side wall opening so that it projects into the interior of the saddlebag 12b and the second of the washers previously removed from the holding rod 46 is placed on this end portion followed by the second one of the nuts previously removed from the holding rod 46.

The bottom of the saddlebag 12b is provided with two non-illustrated openings which are adapted to be aligned with the openings 56b,58b in the brackets 52b,54b of the carrying part 16 (FIG. 2). When the openings in the bottom of the saddlebag 12b are aligned with the openings 56b,58b , washers are placed on two bolts which are thereupon inserted in the two pairs of aligned openings. Once the bolts have been inserted in the aligned openings, another washer is placed on each bolt followed by a nut.

The openings in the saddlebags 12a,12b which receive the free end portions of the holding rod 46, as well as the openings which are aligned with the openings 56a,58a,56b,58b in the carrying part 16 of the support 16,18, need not be specially formed to make the trailer 10. These openings in the saddlebags 12a,12b are the same ones used to mount the saddlebags 12a,12b on the motorcycle 128 and are formed in the factory during production of the saddlebags 12a,12b.

At this time, the nuts holding the saddlebags 12a,12b on the support 16,18 have not been fully tightened in order to permit adjustment of the saddlebags 12a,12b.

The saddlebags 12a,12b are separated from one another by a gap of variable width, and the minimum width of the gap is somewhat greater than the distance between the legs 36 of the U-shaped member 34. A license plate panel 132 seen in FIG. 12 and constituting a center insert is placed between the saddlebags 12a,12b at the rear of the carrying part 16 of the support 16,18. The nuts inside the saddlebags 12a,12b are thereupon tightened sufficiently to hold the license plate panel 132 in place.

Although not shown in FIG. 9, the license plate panel 132 can form part of the kit 122.

The side walls of the saddlebags 12a,12b which are penetrated by the holding rod 46 are each sandwiched between two washers and two nuts. Once the saddlebags 12a,12b and the license plate panel 132 have been properly aligned, the nut outside each side wall undergoes a final tightening. The saddlebags 12a,12b may be made of plastic and, in such an event, the nuts should not be overtightened since this could cause the side walls to crack.

Each of the brackets 42 on the U-shaped member 34 is sandwiched between two nuts which are now tightened against the brackets 42. Likewise, the nuts holding the U-shaped member 34 on the carrying part 16 of the support 16,18 are tightened as are the nuts securing the saddlebags 12a,12b to the carrying part 16.

As mentioned previously, each of the mounting elements 102 of the rear bumper 96 (FIG. 6a) is provided with a hole, and the holes in the mounting elements 102 are designed to be aligned with respective non-illustrated holes in the shorter leg 24b of the frame 20 (FIGS. 2 and 3). The holes in the mounting elements 102 are placed in alignment with the holes in the shorter leg 24b and bolts are passed through the two pairs of aligned holes. Nuts are screwed onto the bolts and tightened to attach the rear bumper 96 to the frame 20.

The saddlebags 12a,12b are provided with lights, and the rear ends of the wires running along the frame 20 and forming part of the wire harness 126 can now be connected to such lights. The connections between the lights and the wires may be plug-and-socket connections.

A license plate light is installed on the license plate panel 132. The license plats light is equipped with wires which are tied in to the wires of the wire harness 126.

The saddlebags 12a,12b come with corner covers which fit under the lights of the saddlebags 12a,12b. These corner covers may have been removed for assembly of the trailer 10 and, if so, can be reinstalled at this time.

Each of the saddlebags 12a,12b is further provided with a side cover mounting tab at the front of the respective saddlebag 12a,12b. Such mounting tabs should be removed by sawing or grinding in order for the tonneau cover 14 to fit properly.

An inner fender in the form of a rectangular metal sheet or plate may be mounted at the rear of the gap between the saddlebags 12a,12b in front of the U-shaped member 34. Mounting of the inner fender can be accomplished by attaching an L-shaped bracket to each of the saddlebags 12a,12b and connecting one longitudinal end of the fender to the brackets. The inner fender may be used to produce a front fender mount. This can be achieved by bending the inner fender so that it extends over the tire 80 and connecting the second longitudinal end of the inner fender to the saddlebags 12a,12b via two additional L-shaped brackets. Rivets may be used to attach the L-shaped brackets to the saddlebags 12a,12b and the inner fender to the brackets.

While not illustrated in FIG. 9, the inner fender and L-shaped brackets can form part of the kit 122.

The tonneau cover 14 is designed to cover the gap between the saddlebags 12a,12b and to be attached to the saddlebags 12a,12b and to the shorter leg 24a of the frame 20 (FIG. 3) by snap action. To this end, female snap portions are mounted on the tonneau cover 14. Cooperating male snap portions are affixed to the saddlebags 12a.12b and the shorter leg 24a of the frame 20, and this can be accomplished by inserting rivets in the saddlebags 12a,12b and the shorter leg 24a. Preferably, the male snap portions are applied to the saddlebags 12a,12b one or two at a time beginning at the rear of the trailer 10. It is advantageous to snap the tonneau cover 14 onto the male snap portions and to stretch the tonneau cover 14 as the male snap portions are applied to the saddlebags 12a,12b.

The typical receiver for hitching a trailer to a tow vehicle includes a ball on which the drawbar or towing member is mounted for pivotal movement. The ball is removed from such a receiver leaving an opening, and the opening 120 in the crosspiece 116 of the hinge 112 (FIG. 8a) is placed in register with the opening in the receiver. When the receiver is in the position which it assumes during use, the axis of the opening in the receiver is vertical and the hinge 112 sits above the receiver with the legs 114 of the hinge 112 extending upward. A bolt serving as a pivot is passed through the opening 120 and the registering opening of the receiver and a nut is screwed onto the bolt. At this time, the nut is only finger tightened. Preferably, a plastic washer is interposed between the hinge 112 and the receiver prior to insertion of the bolt in the opening 120 and the registering opening of the receiver.

Once the nut has been finger tightened, the tow vehicle attachment portion 106b of the drawbar 106 (FIG. 7) is inserted between the legs 114 of the hinge 120 so that the passage 110 in the tow vehicle attachment portion 106b is in alignment with the openings 118 in the legs 114. A bolt serving as a pivot is inserted in the openings 118 and the passage 110 and a nut is screwed onto the bolt. The nut holding the hinge 112 on the receiver is then tightened but is left loose enough to permit smooth pivoting of the hinge 112 relative to the receiver. The nut holding the hinge 112 on the drawbar 106 is similarly tightened to an extent which allows smooth pivoting of the hinge 112 relative to the drawbar 106.

Assembly of the trailer 10 is now complete.

As mentioned earlier, the trike 130 (FIG. 11) is to serve as a tow vehicle for the trailer 10. Upon attachment of the trailer 10 to the trike 130, the section of the wire harness 126 which protrudes from the tow vehicle attachment portion 106b of the drawbar 106 is connected to the electrical system of the trike 130. FIG. 11 shows the trailer 10 hitched to the trike 130.

The forward part of the gap between the saddlebags 12a,12b, that is, the part of the gap in front of the tire 80, can function as an additional storage area. Thus, one or more items to be stored can be placed on the shorter leg 24a of the frame 20 and on the reinforcing member 26 (FIG. 3). Such item or items can be secured, for instance, via rope or straps. By way of example, a cooler or other type of container can be stored in the forward part of the gap between the saddlebags 12a,12b.

The tonneau cover 14 can be replaced by a hard top. Furthermore, a storage unit in addition to the saddlebags 12a,12b may be provided.

Typically, when a motorcycle like the motorcycle 128 of FIG. 10 is converted to a trike 130 (FIG. 11), the saddlebags 12a,12b which were mounted on the motorcycle 128 cannot be used for the trike 130 and are either discarded or placed in storage, In contrast, the trailer 10 of the invention makes it possible to continue using the saddlebags 12a,12b with the trike 130. The trailer 10 can be designed so that the holes in the saddlebags 12a,12b which were used to affix the saddlebags 12a,12b to the motorcycle 128 may be used to mount the saddlebags 12a,12b on the trailer 10.

The employment of a single axle 62 in the form of a cantilever for the tire 80 of the trailer 10 allows an off-the-shelf axle to be used. This makes it possible to reduce the cost of the trailer.

The feet 104 on the bumper 96 permit the trailer 10 to be easily stored by tilting the trailer 10 onto the feet 104. For example, the trailer 10 can be tilted onto the feet 104 and then leaned against a wall for storage.

The drawbar 106 allows the trailer 10 to be hitched to a location of the trike 130 which is at a height different from that of the trailer 10. Thus, the inclined portion 106c of the drawbar 106 can compensate for the height differential. This enables the trailer 10 to have a low center of gravity so that the stability of the trailer 10 is increased. The parallel portions 106a,106b of the drawbar 106, which are joined to one another by the inclined portion 106b and are respectively attached to the trailer 10 and the trike 130, permit the trailer 10 to be securely hitched to the trike 130 in an upright position.

When the trailer 10 is hitched to the trike 130, the hinge 112 defines a horizontal and a vertical pivot axis between the trailer 10 and the trike 130. The vertical pivot axis allows the trailer 10 to smoothly follow the trike 130 around corners and curves while the horizontal axis permits the trike 130 to pass over a bump without uncontrolled bouncing of the trailer 10.

Various modifications are possible within the meaning and range of equivalence of the appended claims.

We claim:

1. A trailer comprising:
a support;
at least one rolling element for carrying said support;
means for connecting said support to a tow vehicle; and
at least one storage unit fixed to said support, said storage unit being designed to be mounted on a motorcycle.

2. The trailer of claim 1, wherein said support comprises a substantially rectangular frame.

3. The trailer of claim 2. wherein said frame has a pair of substantially parallel first legs and a pair of substantially parallel second legs which are longer than said first legs, said support further comprising a mounting element on one of said second legs projecting outward of said frame, and said one storage unit being attached to said mounting element.

4. The trailer of claim 2, wherein said connecting means comprises a towing member having a first portion for attachment to said support and a second portion for attachment to the tow vehicle, one of said first legs being provided with an opening for securing said first portion to said support.

5. The trailer of claim 4, wherein said support further comprises a reinforcing member which bridges said second legs, said reinforcing member being provided with a second opening for securing said first portion to said support.

6. The trailer of claim 1, wherein said support comprises a first part and a second part which define an angle of at least approximately 90 degrees, said one storage unit being secured to both of said parts.

7. The trailer of claim 1, further comprising a single axle on said support, said one rolling element being mounted on said axle.

8. The trailer of claim 7, wherein said axle is cantilevered on said support.

9. The trailer of claim 1, further comprising a bumper on said support, said bumper being provided with at least one foot for carrying said support when said support is tilted.

10. The trailer of claim 1, wherein said connecting means comprises a towing member having a first portion for attachment to said support, a second portion for attachment to the tow vehicle, and a third portion between said first portion and said second portion, said third portion being inclined to said first portion and to said second portion.

11. The trailer of claim 10, wherein said first portion of said towing member is substantially parallel to said second portion of said towing member.

12. The trailer of claim 1, wherein said connecting means comprises a towing member having a first portion for attachment to said support and a second portion for attachment to the tow vehicle, said connecting means further comprising a discrete connecting member for connecting said towing member to the tow vehicle, and said connecting member having a first portion for pivotal attachment to said second portion of said towing member and a second portion for pivotal attachment to the tow vehicle.

13. The trailer of claim 12, wherein said connecting member is generally U-shaped.

14. The trailer of claim 13, wherein said connecting member has a pair of legs and a bridging element joining said legs to one another, said legs defining a gap sized to receive said second portion of said towing member, and said first portion of said connecting member including an opening in each of said legs, said second portion of said towing member being provided with a passage arranged to be aligned with said openings when said second portion of said towing member is located between said legs.

15. The trailer of claim 13, wherein said connecting member has a pair of legs and a bridging element joining said legs to one another, said second portion of said connecting member including an opening in said bridging element.

16. The trailer of claim 12, wherein said first portion of said connecting member comprises first means defining a first pivot axis and said second portion of said connecting member comprises second means defining a second pivot axis, said first pivot axis extending along a first direction and said second pivot axis extending along a second direction which is substantially normal to said first direction.

17. A trailer comprising:
a support;
at least one rolling element for carrying said support; and
means for connecting said support to a tow vehicle, said connecting means including a towing member having a first portion for attachment to said support, a second portion for attachment to the tow vehicle, and a third portion between said first portion and said second portion, said third portion being inclined to said first portion and to said second portion.

18. The trailer of claim 17, wherein said first portion of said towing member is substantially parallel to said second portion of said towing member.

19. A trailer comprising:
a support;
at least one rolling element for carrying said support; and
means for connecting said support to a tow vehicle, said connecting means including a towing member having a first portion for attachment to said support and a second portion for attachment to the tow vehicle, and said connecting means further comprising a discrete connecting member for connecting said towing member to the tow vehicle, said connecting member having a first portion for pivotal attachment to said second portion of said towing member and a second portion for pivotal attachment to the tow vehicle.

20. The trailer of claim 19, wherein said connecting member is generally U-shaped.

21. The trailer of claim 20, wherein said connecting member has a pair of legs and a bridging element joining said legs to one another, said legs defining a gap sized to receive said second portion of said towing member, and said first portion of said connecting member including an opening in each of said legs, said second portion of said towing member being provided with a passage arranged to be aligned with said openings when said second portion of said towing member is located between said legs.

22. The trailer of claim 20, wherein said connecting member has a pair of legs and a bridging element joining said legs to one another, said second portion of said connecting member including an opening in said bridging element.

23. The trailer of claim 19, wherein said first portion of said connecting member comprises first means defining a first pivot axis and said second portion of said connecting member comprises second means defining a second pivot axis, said first pivot axis extending along a first direction and said second pivot axis extending along a second direction which is substantially normal to said first direction.

24. A trailer comprising:
a support;
means for connecting said support to a tow vehicle;
a single axle on said support; and
a rolling element on said axle for carrying said support.

25. The trailer of claim 24, wherein said axle is cantilevered on said support.

26. A kit for making a trailer comprising:
a support;
means for connecting said support to a tow vehicle;
a rolling element for carrying said support; and
means for mounting said rolling element on said support.

27. A method of making and using a trailer comprising the steps of:
removing a storage unit from a motorcycle;
assembling a support and a rolling element for carrying said support;
mounting said storage unit on said support; and
connecting said support to a tow vehicle.

28. The method of claim 27, wherein said tow vehicle is a trike derived from said motorcycle.

29. The method of claim 27, wherein said support is provided with a single axle which is cantilevered on said support and the assembling step comprises mounting said rolling element on said axle.

30. The method of claim 27, wherein the connecting step comprises attaching a towing member to said support, pivotally attaching said towing member to a connecting member, and pivotally attaching said connecting member to said tow vehicle.

31. A method of making and using a trailer comprising the steps of:
assembling a support and a rolling element for carrying said support; and
connecting said support to a tow vehicle, the connecting step including attaching a towing member to said support, pivotally attaching said towing member to a connecting member, and pivotally attaching said connecting member to said tow vehicle.

32. The method of claim 31, wherein said towing member is attached to said connecting member for relative pivotal movement on a first axis and said connecting member is attached to said tow vehicle for relative pivotal movement on a second axis, said first axis extending along a first direction and said second axis extending along a second direction which is substantially normal to said first direction.

33. A method of making and using a trailer comprising the steps of:
assembling a support and a rolling element for carrying said support; and
connecting said support to a tow vehicle, said support being provided with a single axle, and the assembling step including mounting said rolling element on said axle.

34. The method of claim 33, wherein the assembling step comprises cantilevering said axle on said support.
